(19) United States
(12) Patent Application Publication
(10) Pub. No.: US 2006/0059763 A1
(43) Pub. Date: Mar. 23, 2006

(54) Expandable net

(76) Inventors: Nicholas Passint, Rice Lake, WI (US); Bryan Wilson, Madison, WI (US); Joseph Brian Cessna, Madison, WI (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/943,556

(22) Filed: Sep. 17, 2004

(51) Int. Cl. A01K 77/00

(52) U.S. Cl. 43/11; 43/7

(57) ABSTRACT

The present invention relates to an expandable net device. An embodiment includes an expandable structure that is configurable in an expanded configuration and a contracted configuration. In an embodiment, the contracted configuration can facilitate insertion of the net device through an ice fishing hole.

### FIELD OF THE INVENTION

The present invention relates to an expandable net device. An embodiment includes an expandable structure that is configurable in an expanded configuration and a contracted configuration. In an embodiment, the contracted configuration can facilitate insertion of the net device through an ice fishing hole.

### BACKGROUND OF THE INVENTION

Nets can be used for a variety of purposes, such as to capture animals or retrieve objects. Fisherman frequently use a net to retrieve a fish from water. A fish net can, for example, reduce the risk of losing a fish due to line breakage. Fish nets used for fishing from a boat or pier are typically generously-sized to facilitate retrieval of a fish. Large nets, however, can be inconvenient to transport and store. Conventional fish nets can generally not be used in ice fishing, because the ice fishing hole us usually not large enough to accommodate a large net structure. Improved net devices are needed.

### SUMMARY OF THE INVENTION

The present invention relates to an expandable net device. An embodiment includes an expandable structure that can be configurable in an expanded configuration and a contracted configuration. In an embodiment, the contracted configuration can facilitate insertion of the net device through an ice fishing hole.

An embodiment of a fishing net device includes an expandable structure having an expanded configuration and a contracted configuration, a control mechanism that can be configured to move the expandable structure from the contracted configuration to the expanded configuration, and a net that can be coupled to the expandable structure. The fishing net device can be configured for ice fishing use: the fishing net device can be configured to be at least partially inserted through a hole in a sheet of ice, expanded under the ice by manipulation of the control mechanism, contracted around a fish, and moved back up through the hole in the ice. The control mechanism can be configured to be operable above the ice when the expandable structure is submerged under the ice.

An embodiment of a device configured to receive a net can include an elongated member having a top end and a bottom end and an expandable structure that includes a plurality of arms that are pivotably coupled to the elongated member. The plurality of arms can have a lower end that can be pivotably coupled to the elongated member and an upwardly extending body. The expandable structure can be configured to receive a net.

An embodiment of an expandable net device can include a tube comprising portions defining an internal cavity, a shaft that extends through the cavity in the center tube, a plurality of net arms that are coupled to the center shaft, a plurality of control arms that are coupled to the center tube and coupled to the net arms, and a net that can be coupled to the net arms. The device can be configured such that sliding the shaft in a first direction with respect to the tube causes the net arms to rotate generally toward the tube to contract the net and sliding the shaft in a second direction with respect to the tube causes the arms to rotate generally away from the tube to expand the net.

An embodiment of an expandable fishing net includes an elongated structure, a flexible arm that can be slidably coupled to the elongated structure, a net that can be coupled to the flexible arm, and a cable that can be coupled to the flexible arm and the elongated structure. The cable can be configured to pull the flexible arm toward the elongated structure. The flexible arm can be configured such that sliding the flexible arm with respect to the elongated structure moves the flexible arm from a contracted configuration to an extended configuration.

A method of using a fish net can include providing a fish net having an expandable structure and a net material that can be coupled to the expandable structure, submerging a portion of the fish net in a body of water, expanding the expandable structure beneath the water, positioning the expandable structure in relation to a fish, contracting the expandable structure around the fish; and moving the expandable structure up out of the water. In a method that is adapted for ice fishing, submerging a portion of the fish net in a body of water includes moving a portion of the fish net through a hole in an ice sheet; and moving the expandable structure up out of the water includes moving the expandable structure up through the hole in the ice sheet.

### BRIEF DESCRIPTION OF THE DRAWINGS

FIG. 1 is a front view of a net device in an expanded configuration.

FIG. 2 is a front view of a net device in a contracted configuration.

FIG. 3 is an enlarged view of a net device in an expanded configuration.

FIG. 4 is perspective view of a bushing.

FIG. 5 is a perspective view of a hinge structure.

FIG. 6 is a perspective view of a coupling member.

FIG. 7 is a perspective view of a hinge structure.

FIG. 8 is a perspective view of a hinge structure that is configured to slide over a tube.

FIG. 9 is a perspective view of a hinge structure that is configured to slide over an arm.

FIG. 10 shows an alternative embodiment of a net device that includes attachment hooks and arm pads.

FIGS. 11A-11D show a net device coupled to an all-terrain vehicle, an auger, and a sled.

FIG. 12 shows a net device that can be broken into sections.

FIGS. 13A and 13B show embodiments of a net device that use cable and spring systems.

FIG. 14A shows a flexible arm or a net device in three positions.

FIG. 14B shows a net device with a flexible arm in a contracted position.

FIG. 14C shows a net device with a flexible arm in a partially extended position.

FIG. 14D shows a net device with a flexible arm in an expanded position.

FIG. 15 shows a carrying case for a net device.

### DETAILED DESCRIPTION OF THE INVENTION

A net device can include an expandable structure and net that can be coupled to the expandable structure. The expandable structure can be configured in an expanded configuration. The device can be configured such that when the expandable structure is in the expanded configuration, the net device can be used to retrieve an object, such as a fish or other animal. In an embodiment, the expandable structure can also be configured in a contracted configuration. In an embodiment, the contracted configuration can facilitate storage and/or transport of the net device. For example, the net device can be constructed to fit in storage spaces in a boat or vehicle.

In an embodiment, the net device can be configured for use in an ice fishing application. For example, the net device can be configured such that, when the net device is in a contracted configuration, an expandable portion of the net device fits through an ice fishing hole. The expandable portion can be configured so that when it is expanded under the ice, it facilitates retrieval of a fish through the hole. For example, in a method of using the net device, the expandable portion can be expanded, the fish can be positioned between the net device and the ice, and then expandable portion can be contracted to surround, capture, or otherwise restrain the movement of the fish. The fish and expandable portion can then be urged upward through the ice fishing hole to safely land the fish.

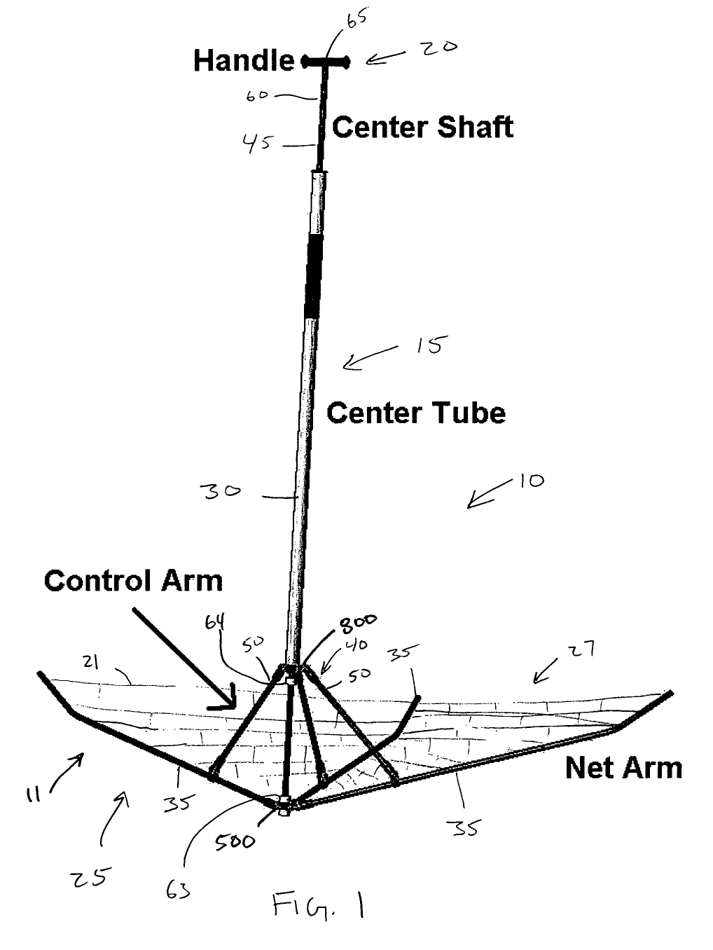

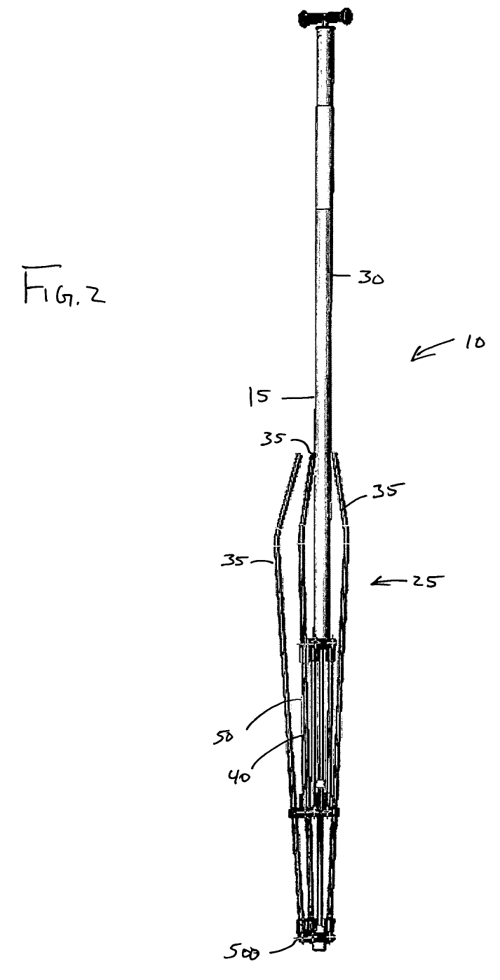

Referring now to FIG. 1, an embodiment of a net device 10 can include an expandable structure 11. The expandable structure can include a main structure 15 and a peripheral system 25. A net 21 can coupled to the peripheral system. As used herein, “net” is intended to refer to a flexible structure that is porous to water but can lift an object. For example, the net can be a matrix of connected strings, as is known to those skilled in the art. Other structures, such as porous weaved materials, can also be used. In an embodiment, the peripheral system can be configured to expand away from the main structure to expand or open the net. A drive system 20 can be configured to move the peripheral system 25, so that the peripheral system can be selectively expanded and contracted with respect to the main structure. FIG. 1 shows the peripheral system 25 in an expanded configuration. FIG. 2 shows the peripheral system 25 in a contracted configuration. In an embodiment, the net can be configured in an open position when the peripheral system is configured in an expanded configuration.

In an embodiment, the main structure 15 of a net device can include an elongated structural member 30. The drive system 20 and the peripheral system 25 can be coupled to the elongated structural member 30. In an embodiment, the peripheral system can include at least one net arm 35, to which the net can be connected or coupled. The net arm 35 can be configured to be moved by the drive system to allow for expand and contraction of the peripheral system. In an embodiment, a linkage system 40 can be configured to facilitate expansion and contraction of the net arm 35. The linkage system can, for example, include a linkage member that is coupled to the net arm 35 and to the main structure 15.

In an embodiment, the drive system can include an elongated drive member 45, such as a shaft, that is slidably coupled to the elongated member 30. In an embodiment, the elongated drive member 45 can be configured such that displacing the elongated drive member 45 with respect to the elongated member 30 drives the linkage system 40 to expand or contract the net arms. For example, the drive system can be configured such that urging the elongated member 30 through the elongated member biases the net arm 35 toward or away from the elongated member.

In an embodiment, the elongated structural member 30 can include portions that define a cavity. For example, the elongated member can be a hollow member, such as a tube or cylinder. The cross-section of the elongated structural member can be any of a variety of shapes, including circular, ovular, triangular, square, pentagonal, or irregular. In an embodiment, the elongated drive member 40 can be configured as a shaft that extends through the cavity of the structural member 30. In an embodiment, the linkage system 40 can be coupled to both the elongated structural member 30 and the elongated drive member 45.

In an embodiment, the linkage system 40 can include at least one linkage arm 50 that is coupled to at least one net arm 35. For example, in an embodiment, the linkage arm 50 can be coupled to the elongated structural member 30 and a net arm 35, which can be pivotably coupled to the elongated drive member 45.

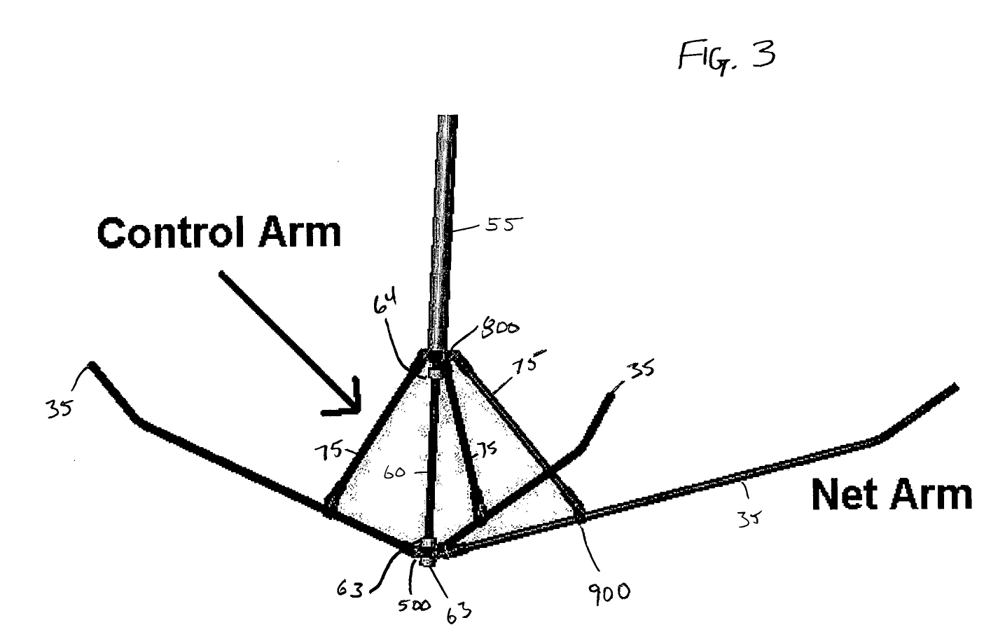

Referring now to FIG. 3, a preferred embodiment will now be described. A preferred embodiment of a net device includes a center tube 55 and a center shaft 60. Preferably, the center shaft 60 can be slidably disposed within the center tube 55. A handle 65 (shown in FIG. 1) can be coupled to an upper end of the center shaft 60. At least one net arm 35 can be pivotably coupled to the center shaft 60. At least one control arm 75 can be coupled to the net arm 35 and to the center tube 55. Preferably, the net device includes a plurality of net arms 35, and each net arm 35 is coupled to the center tube 55 by a control arm 75, but other arrangements are possible. For example, in an embodiment, the net arms can be coupled to each other and coupled to the center tube by a single control arm. In addition, in an alternative embodiment, the functions of the center tube and the center shaft can be reversed, such that the net arms are pivotably coupled to the tube and control arms are pivotably to the shaft. In one embodiment, this can be accomplished by providing at least one slot 70 in the center tube, which allows for coupling of a control arm to the center shaft.

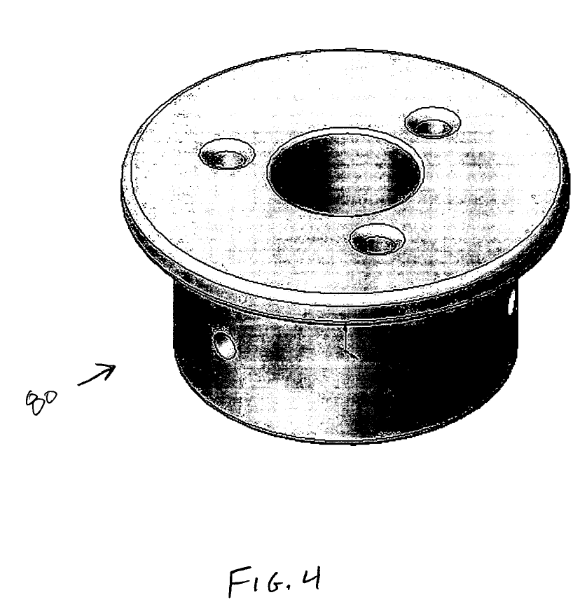

The net device is preferably configured such that sliding the shaft 60 in a first direction with respect to the tube 55 causes the net arms 35 to rotate generally toward the tube to contract the net, and sliding the shaft in a second direction with respect to the tube causes the arms to rotate generally away from the tube to expand the net. In an embodiment, a bushing 80, shown in FIG. 4, can be configured to allow the shaft 60 to slide within the tube 55. In a preferred embodiment, a bushing 80 is coupled to each end of the tube 55.

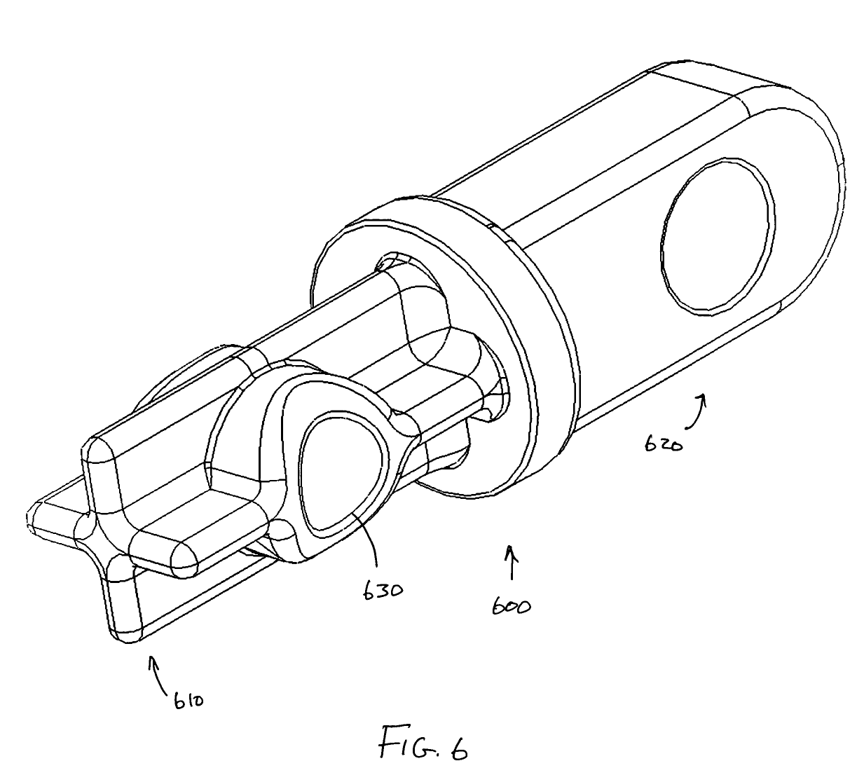

In a preferred embodiment, the net arms can be coupled to the shaft with a shaft hinge 500. The shaft hinge 500 can be configured with portions that define an interior region 510 into which a hinged member can be inserted. In an embodiment, an end of a net arm can be shaped and configured to be received into the interior region 510. In another embodiment, a coupling member 600, shown in FIG. 6, can be configured to be coupled the net arm to the shaft hinge. Coupling member 600 can include a first end 610 that is configured to be coupled to the net arm 35 and a second end 620 that is configured to be received within the interior region 510 on the shaft hinge 500.

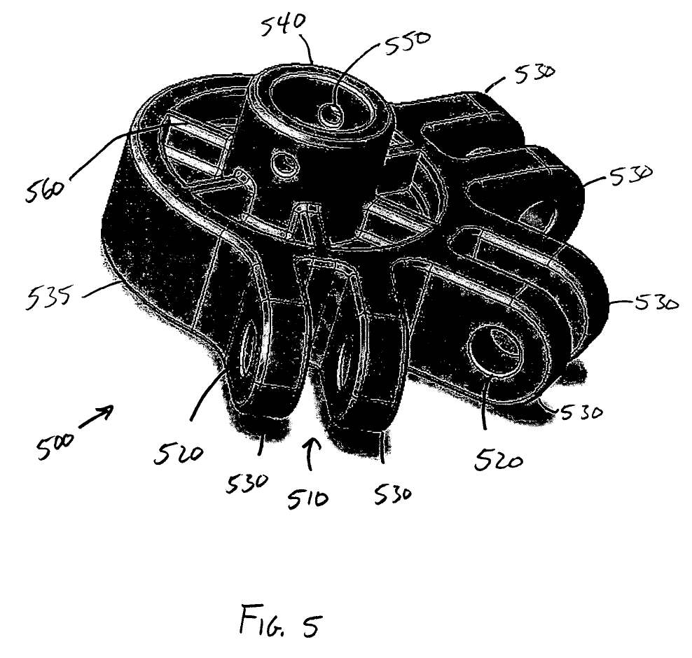

Referring again to FIG. 5, holes 520 can be provided in the shaft hinge 500. The holes 520 can be configured to allow for insertion of a pin (not shown) through a hinged member to pivotably couple the hinged member to the shaft hinge. The shaft hinge can include an upwardly extending protrusion 540 that is configured to receive the shaft 60. Holes 550 can be provided to allow for insertion of a bolt or screw to connect the shaft to the hinge 500. In an alternative embodiment, the upwardly extending protrusion 540 can be configured to fit within the shaft 60. In another embodiment, the shaft can extend through the hinge, and one or more sleeves 63 (shown in FIG. 3) can be used to couple the hinge to the shaft. Other alternative coupling structures known to one skilled in the art can be used to couple the hinges 500, 600 to the tube and shaft. For example, the hinges can be coupled or connected to the tube and shaft respectively using a fastener such as a screw or bolt, a weld, a bracket, a press fit configuration.

FIG. 5 shows protrusions 530 that define interior region 510. In an alternative embodiment, protrusions 530 can be omitted, and body 535 of the hinge can be enlarged if necessary to that the interior region 510 can be defined by recessed portions in the body of the hinge. In another alternative configuration, the parts on the hinge and the net arm (or coupling member) can be reversed, so the net arm defines a recessed portion that is configured to receive a protrusion on the hinge. Other hinge configurations are possible. The hinge can be provided with webbed sections 560 to provide increased rigidity. FIG. 5 shows a shaft hinge that provides three interior regions 510, but more or fewer interior regions are possible.

Referring again to FIG. 6, the coupling member 600 can be shaped to fit within a hollow portion at an end of a net arm. A screw, bolt, or pin can be inserted through the net arm and through a hole 630 in the coupling member.

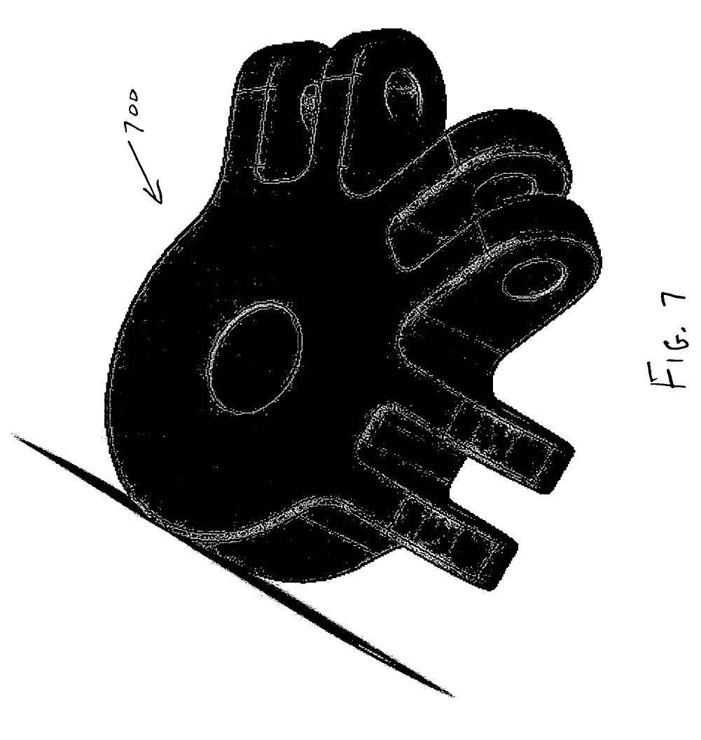

FIG. 7 shows an alternative embodiment of a shaft hinge 700. Shaft hinge 700 can be coupled to a shaft by sleeves as shown in FIG. 3. Shaft hinge 700 shows three sets of protrusions 710 spaced 40 degrees apart. In alternative embodiments, different protrusion spacing or different numbers of protrusions can be used. For example, four protrusions can be spaced 90 degrees apart to provide a net device with a 360-degree net. Other configurations are possible.

Referring not to FIG. 8, a tube hinge 800 can be configured with a bore 810 that is configured to receive the tube 55. A recessed portion 820 can be defined by protrusions 830 and configured to receive a control arm 50 or a coupling member that it coupled to a control arm. Holes 840 can be provided to allow for insertion of pins to pivotably couple the tube hinge 800 to the control arm 55. Holes 860 can be provided in the body 850 of the tube hinge 800 to allow for insertion of screws, such as set screws, to couple the tube hinge 800 to the tube 55.

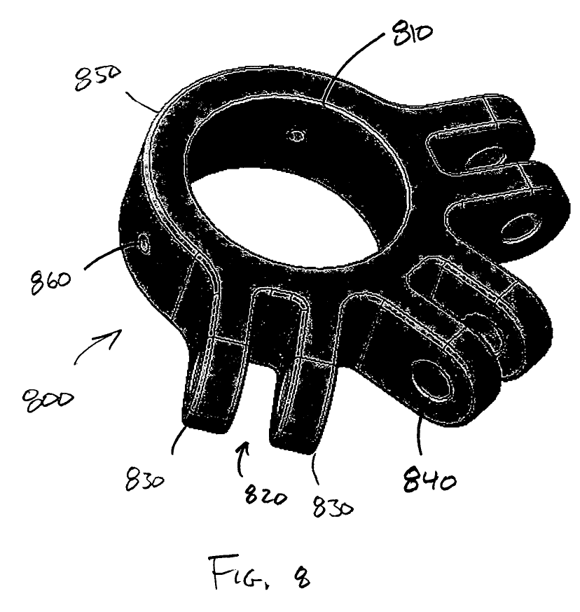

An arm hinge 900 is shown in FIG. 9. The arm hinge 900 can be configured with a bore 910 for receiving an arm, such as a net arm 35 or a link arm 55. An interior region 920 can be configured to receive a coupling member or an end portion of an arm. Holes 930 can be provided in the arm hinge 900 to allow for insertion of a pin to pivotably couple the arm hinge 900 to the coupling member or arm. The arm hinge 900 can also be configured to receive a bushing (not shown) and a clip.

Referring again to FIG. 2, the handle can be pulled upwardly to expand the peripheral structure. Urging the shaft sleeve 500 upwardly causes the arms 35 to pivot away from the shaft 55. A stop on the shaft 63 meets with a stop 64 that is coupled to the tube, thereby avoiding over-extension of the arms 35. The shaft can be pushed downwardly to contract the arms toward the shaft to put the peripheral structure back in the contracted configuration. It is understood that there are various ways to move the shaft with respect to the tube (or vice versa): The shaft can be pulled or pushed through the tube; the tube can be pushed or pulled over the shaft, or the shaft and tube can be moved simultaneously.

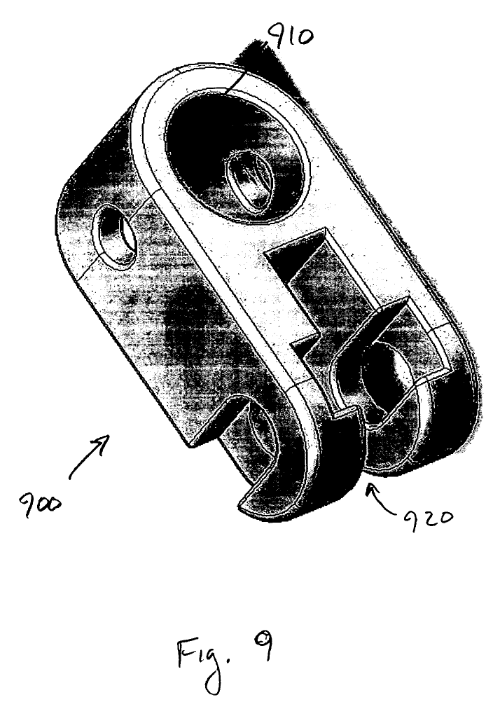

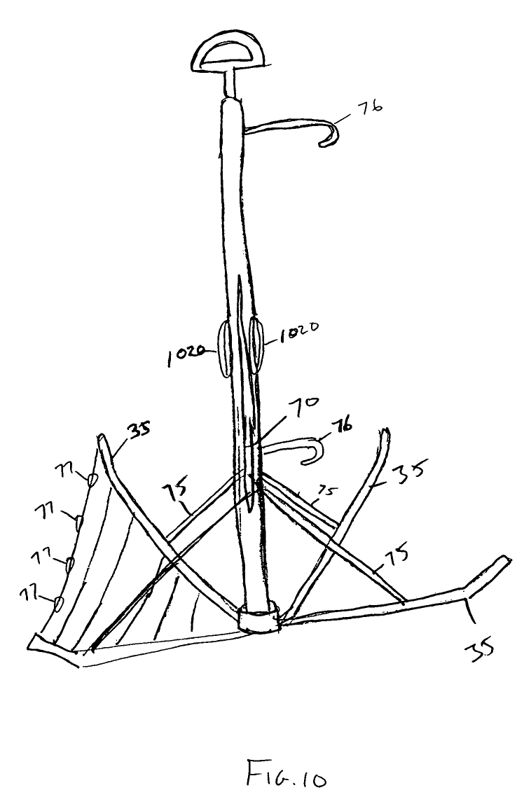

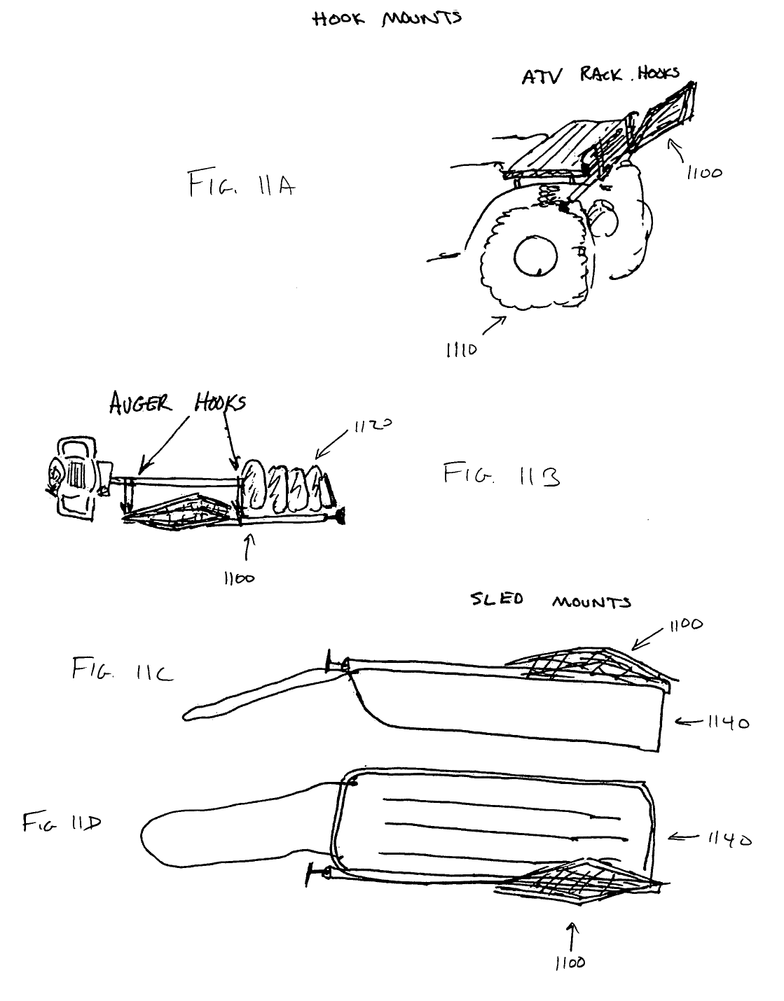

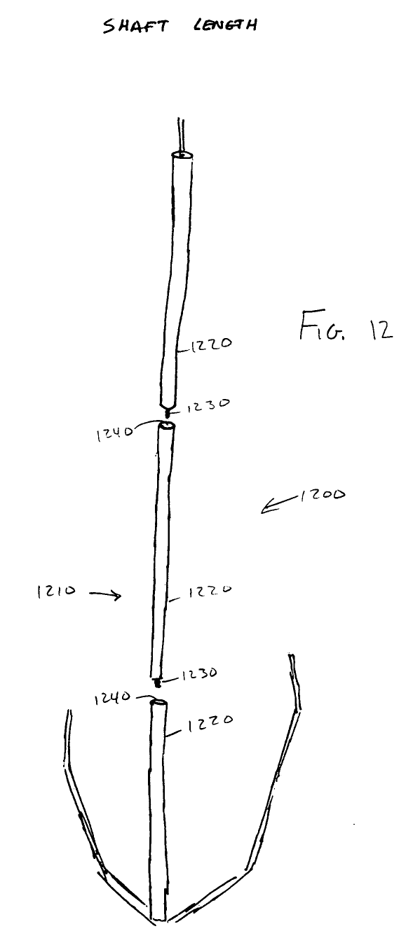

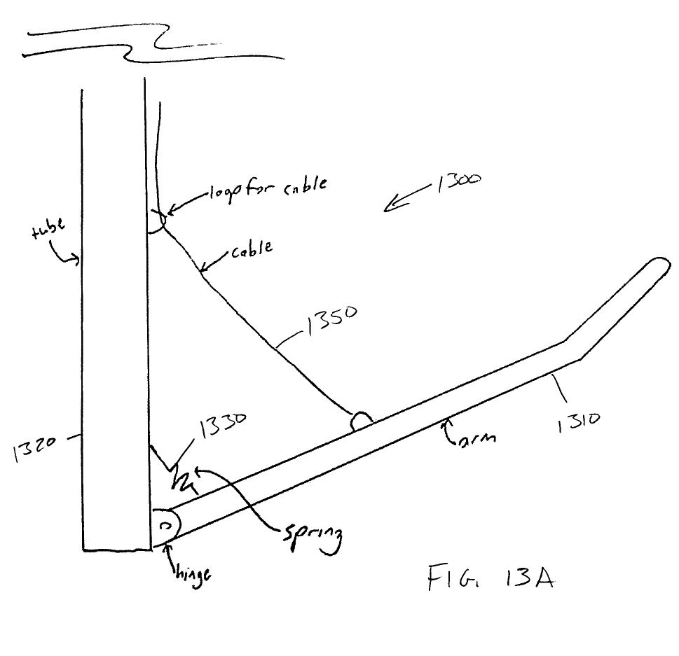

Various alternative embodiments are possible. In an embodiment, a receiving mechanism can be configured to guide the net arms into position in the closed configuration. For example, the net arms can be received into a pad 1020 that is coupled to the tube, as shown in FIG. 10. In an embodiment, hooks can be provided on the net device to accommodate coupling the net device to an object, such as an auger, bucket, sled, or vehicle, to facilitate transportation. FIG. 10 shows hooks 76 that can be configured to couple to an object. In an embodiment, the hooks 76 can be pivotably coupled to the tube, so that the hooks can be folded out of the way when they are not in use. In another embodiment, the hooks can be removably coupled to the net device. FIG. 11A shows a net device 1100 that is configured to be coupled to an all-terrain vehicle 1110. FIG. 11B shows a net device 1100 that is coupled to an auger 1130. FIGS. 11C and 11D show a net device 1100 that is configured to be coupled to a sled 1140.

In an embodiment, the center tube and/or center shaft can be varied in length or broken down. This can be accomplished, for example, by providing sections in the center tube and/or center shaft that are detachable, removable, or foldable. FIG. 12 shows a net device 1200 that has a tube 1210 with separate sections 1220. In an embodiment, the sections can include male and female threaded portions 1230, 1240 that are configured to connect the sections. Providing variable shaft and tube lengths can accommodate storage or transport of the net device. In addition, longer tubes and shafts can be advantageous for operating the net device in thick ice. In an embodiment, the center shaft can be lengthened by adding a section to the shaft.

In an embodiment, a biasing system such as a spring can be provided to bias the net arms to a particular configuration. For example, in one embodiment, the net arms can be biased toward the contracted configuration to accommodate transport and storage. In an embodiment, a spring can be configured into the tube and coupled to the shaft through techniques known to those skilled in the art. In another embodiment, a spring can be configured to bias a net arm away from the tube.

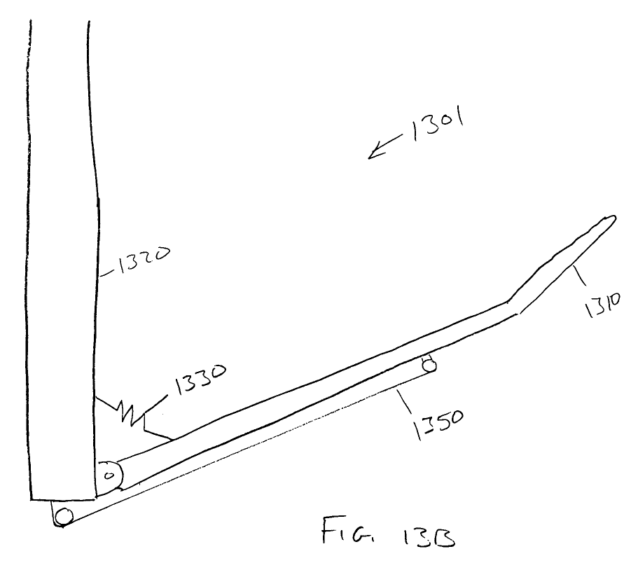

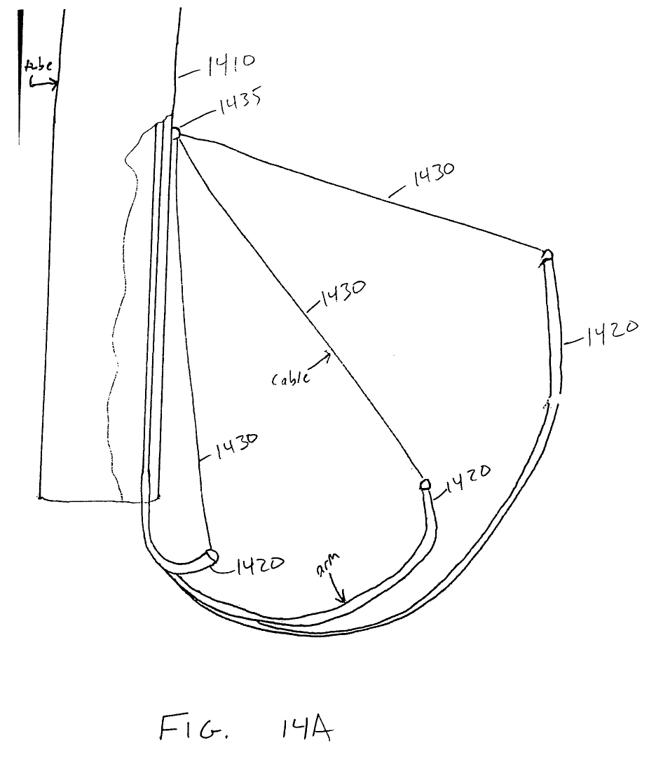

In an embodiment, a cable system can be configured to move the peripheral system between a contracted configuration and an expanded configuration. In an embodiment, a cable and spring system can be configured to expand and retract the net. FIG. 13A shows a schematic representation of an embodiment of a net device 1300 that uses a spring and cable system. A net arm 1310 can be pivotably coupled to a main structure 1320, which can, for example, be a tube. A hinge 1340, for example, can be used to pivotably couple the net arm 1310 to the main structure 1320. A spring 1330 can be configured to bias the net arm 1310 toward the main structure 1320. A cable 1350 can be configured to pull the net arm toward a contracted configuration, i.e. toward the main structure 1320. In an embodiment, a ring 1360 can be coupled to the main structure, and the cable can run through the ring.

In an alternative net device 1301, shown in FIG. 13B, a cable can be configured to pull the net arm toward an expanded configuration, instead of toward a contracted configuration. The cable 1300 can be configured to run inside the main structure 1320. The spring 1330 can be configured to bias the net arm toward a contracted configuration, i.e. toward the main structure 1320.

In an embodiment, the net can be configured to recede inside the tube when the peripheral system is moved toward the closed configuration. This can facilitate storage and transport and avoid tangling with fishing lines, hooks, and the like.

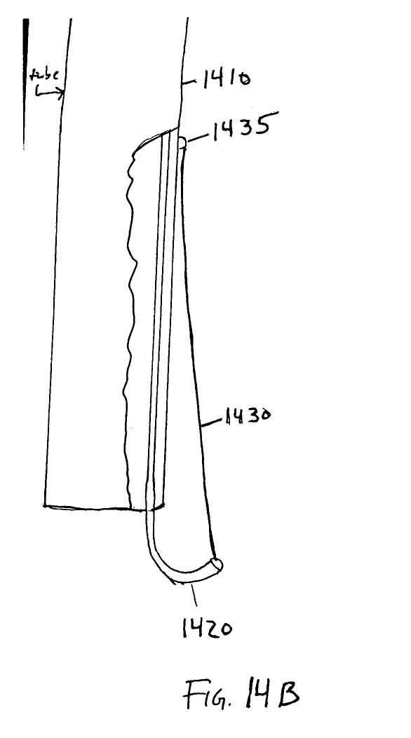

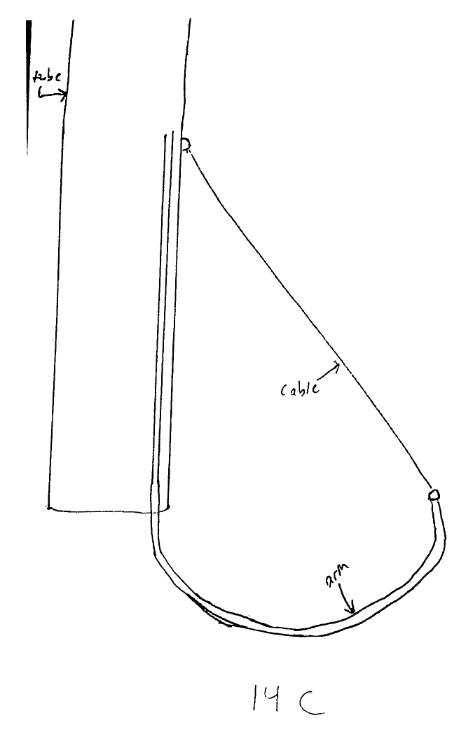

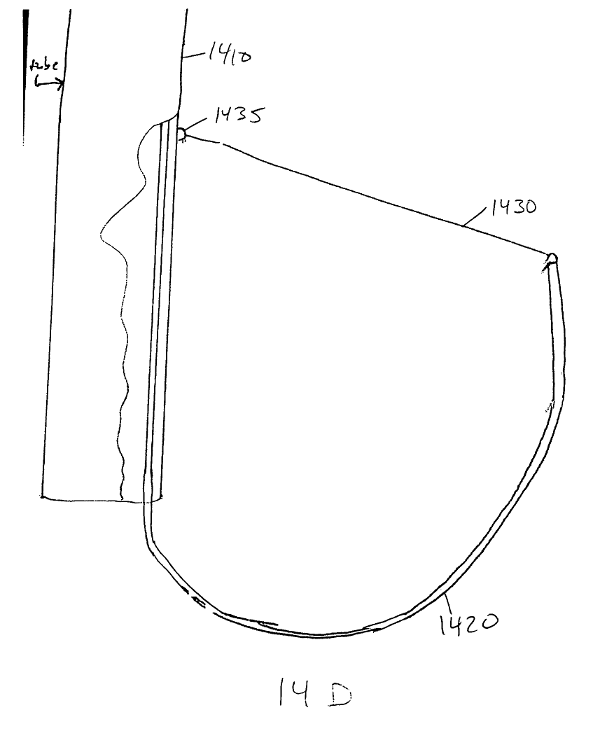

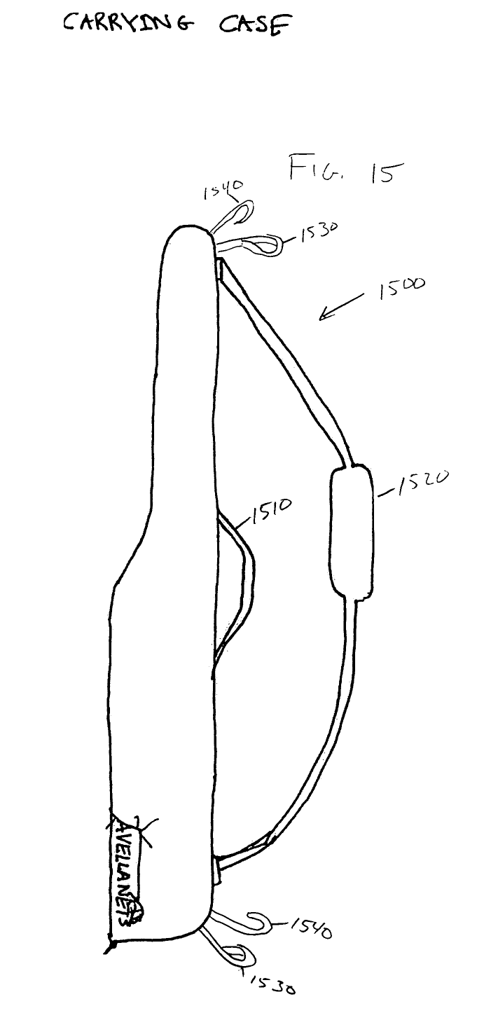

FIGS. 14A-D show an alternative embodiment of a net device 1400. A structure 1410 can be configured to house a flexible net arm 1420. The structure 1410 can, for example, be a tube. FIG. 14D shows a net arm 1420 in three different positions. FIG. 14B shows a net arm 1420 in a contracted configuration. FIG. 14C shows a net arm 1420 in a partially extended (expanded) configuration. As used in reference to the embodiment shown in FIGS. 14A-D, “expanded” and “extended” are used interchangeably. FIG. 14D shows a net arm 1420 in an extended configuration.

A net (not shown) can be coupled to the net arms 1420. In an embodiment, at least a portion of the net arms and net can be contained within the structure 1410 in a contracted configuration, as shown in FIG. 14A. The net arm 1420 can be configured so that it can be urged outwardly from the tube toward an expanded configuration, as shown in FIGS. 14C and 14D. A cable 1430 can be coupled to the structure 1410 and to net arm 1420. The cable 1430 can be configured to pull the net arm 1420 upwardly when the net arm 1420 is urged through the structure 1410. As shown in FIG. 14D, the net arm 1420 and net can be pulled upwardly by the cable when the net and net arm are in the expanded configuration. In an embodiment, a handle (not shown) can be coupled to net arm and configured to facilitate urging the net arm through the structure, so that the handle can be used to move the net and net arms 1420 from a contracted configuration to an expanded configuration.

In an embodiment, cable 1430 can be a fixed length and can be coupled to an attachment point 1435 on the structure 1410. In an embodiment, the device can be configured to allow for adjustment of the tension in the cable. For example, in an embodiment, the attachment point 1435 on the structure can be adjustable. The length of the cable can also be adjustable.

A net arm device can also be provided with a carrying case 1500, shown in FIG. 15. The carrying case can be configured with a handle 1510 and/or a shoulder strap 1520. The carrying case 1500 can also be configured with straps 1530 or hooks 1540 that are configured to couple the case to an auger, sled, ATV, or other object.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “adapted and configured” describes a system, apparatus, or other structure that is constructed or configured to perform a particular task or adopt a particular configuration. The phrase “adapted and configured” can be used interchangeably with other similar phrases such as arranged and configured, constructed and arranged, adapted, constructed, manufactured and arranged, and the like.

All publications and patent applications in this specification are indicative of the level of ordinary skill in the art to which this invention pertains. All of the U.S. patents and published U.S. patent applications referenced in this application are incorporated by reference as if fully reproduced herein.

The invention has been described with reference to various specific and preferred embodiments and techniques. However, it should be understood that many variations and modifications may be made while remaining within the spirit and scope of the invention.

1. A fishing net device comprising:
an expandable structure having an expanded configuration and a contracted configuration;
a control mechanism that is configured to move the expandable structure from the contracted configuration to the expanded configuration; and
a net that is coupled to the expandable structure;
wherein the fishing net device is configured for ice fishing use, the fishing net device being configured to be at least partially inserted through a hole in a sheet of ice, expanded under the ice by manipulation of the control mechanism, contracted around a fish, and moved back up through the hole in the ice, the control mechanism being configured to be operable above the ice when the expandable structure is submerged under the ice.

2. The fishing net device of claim 1 wherein the expandable structure comprises an elongated member and a plurality of arms that are pivotably coupled to the elongated member, the control mechanism being configured to move the arms relative to the elongated member to expand the expandable structure.

3. The fishing net device of claim 2 wherein the elongated member comprises portions defining a cavity and the control mechanism comprises a shaft that extends through the cavity in the elongated member, the shaft member being operatively coupled to the arms to expand the arms away from the elongated member.

4. The fishing net device of claim 3 wherein sliding the shaft in a first direction with respect to the tube causes the net arms to rotate generally toward the tube to contract the net and sliding the shaft in a second direction with respect to the tube causes the arms to rotate generally away from the tube to expand the net.

5. The fishing net device of claim 4 wherein the control mechanism is configured to be operated by at least one of:
pushing the shaft through the tube; and
pulling the tube over the shaft.

6. The fishing net device of claim 1 wherein the expandable structure comprises an elongated member and at least one flexible arm that is movably coupled to the elongated member.

7. The fishing net device of claim 6 wherein the expandable structure further comprises a cable that is coupled to the flexible arm, the cable being configured to pull the flexible arm toward the elongated member.

8. The fishing net device of claim 7 wherein the expandable structure comprises portions defining a hollow structure that is configured to receive the flexible arm, the flexible arm being slidable within the hollow structure.

9. The fishing net device of claim 1 wherein the expandable structure comprises:
a first member;
a second member that is slidably coupled to the first member;
at least one net arm that is coupled to the second member, the net being coupled to the net arm;
at least one linkage arm that is coupled to the first member and to the net arm, the linkage arm being configured such that displacing the second member with respect to the first member pivots the net arm with respect to the first member.

10. The fishing net device of claim 9 wherein the device comprises a plurality of net arms and a plurality of linkage arms that are coupled to the plurality of net arms.

11. The fishing net device of claim 10 wherein each net arm is coupled to one linkage arm.

12. The fishing net device of claim 10 wherein net arms and linkage arms are arranged in pairs.

13. The fishing net device of claim 12 wherein the first and second members comprise respective top and bottom ends, the net arms being pivotably coupled to the bottom end of the second member and the linkage arms being pivotably coupled to the first member and to the net arm.

14. The fishing net device of claim 9 wherein the first member comprises portions defining a central cavity and the second member is slidably disposed within the cavity in the first member.

15. The fishing net device of claim 9 wherein the second member is rigid.

16. A device configured to receive a net, the device comprising:
an elongated member having a top end and a bottom end; and
an expandable structure comprising a plurality of arms that are pivotably coupled to the elongated member, each of the plurality of arms having a lower end that is pivotably coupled to the elongated member and an upwardly extending body, wherein the expandable structure is configured to receive a net.

17. The device of claim 16 wherein the arms are each rotatable through a respective rotation plane, the rotation planes for the arms intersecting at a substantially common axis.

18. The device of claim 16 further comprising a net that is coupled to the expandable structure.

19. The device of claim 18 wherein the device is configured for use in an ice fishing environment.

20. The device of claim 19 wherein the expandable structure is configurable in a compact configuration and an expanded configuration, the net being coupled to the structure to define an interior region; the structure and net being adapted to receive a fish into the interior region when the structure is in the compact configuration and further being configured to fit through a hole in an ice surface when the structure in the compact configuration.

21. An expandable net device comprising:
a tube comprising portions defining an internal cavity;
a shaft that extends through the cavity in the center tube;
a plurality of net arms that are coupled to the center shaft;
a plurality of control arms that are coupled to the center tube and coupled to the net arms; and
a net that is coupled to the net arms;
wherein sliding the shaft in a first direction with respect to the tube causes the net arms to rotate generally toward the tube to contract the net and sliding the shaft in a second direction with respect to the tube causes the arms to rotate generally away from the tube to expand the net.

22. The expandable net device of claim 21 further comprising a hinge mechanism that is slidably disposed over the tube, the control arms being pivotably coupled to the hinge mechanism.

23. An expandable fishing net comprising:
an elongated structure;
a flexible arm that is slidably coupled to the elongated structure;
a net that is coupled to the flexible arm;
a cable that is coupled to the flexible arm and the elongated structure, the cable being configured to pull the flexible arm toward the elongated structure;
wherein the flexible arm is configured such that sliding the flexible arm with respect to the elongated structure moves the flexible arm from a contracted configuration to an extended configuration.

24. The expandable fishing net of claim 24 wherein the elongated structure comprises a portion defining a hollow cavity in which the flexible arm can be received.

25. A method of using a fish net, the method comprising:
providing a fish net having an expandable structure, a net material being coupled to the expandable structure;
submerging a portion of the fish net in a body of water;
expanding the expandable structure beneath the water;
positioning the expandable structure in relation to a fish;
contracting the expandable structure around the fish; and
moving the expandable structure up out of the water.

26. The method of ice fishing of claim 25 wherein:
submerging a portion of the fish net in a body of water comprises moving a portion of the fish net through a hole in an ice sheet; and
moving the expandable structure up out of the water comprises moving the expandable structure up through the hole in the ice sheet.
